(19) United States
(12) Patent Application Publication
(10) Pub. No.: US 2024/0351376 A1
(43) Pub. Date: Oct. 24, 2024

(54) NOVEL TIRE STRUCTURE

(71) Applicant: XIAMEN LENCO CO., LTD., Fujian (CN)

(72) Inventor: PAI-CHI CHENG, Fujian (CN)

(21) Appl. No.: 18/534,761

(22) Filed: Dec. 11, 2023

(51) Int. Cl. B60C 5/16; B60C 29/02

(52) U.S. Cl. CPC B60C 5/16; B60C 29/02

(57) ABSTRACT

A tire structure, including a rim, an outer tire, an inner tube, and an inflating valve; an outer peripheral surface of the rim is provided with a mounting groove; tire beads of the outer tire are hermetically connected with side walls of the mounting groove, so that a hermetically sealed air cavity is formed between the rim and the outer tire; the inner tube is annular and made of an elastic porous material, with a sectional size larger than that of the air cavity; the inner tube is disposed in the air cavity so that an outer surface of the inner tube is tightly attached to an inner wall of the air cavity; the inflating valve is mounted to the rim to inflate the air cavity and the inner tube. Impact force can be absorbed to protect the rim even when the tire is not completely inflated.

### BACKGROUND OF THE INVENTION

The present invention relates to the technical field of tires, and in particular to a novel tire structure.

Tubeless pneumatic tires, such as vacuum tires, also known as low pressure tires and inflatable pneumatic tires, have been increasingly used in transportation means such as bicycles, motorcycles, limousines, passenger cars, and trucks because of their high elasticity, wear resistance, good adhesion and heat dissipation performance. Among these transportation means, bicycles are divided in different kinds according to different uses, and bicycles of different kinds need to be configured with different kinds of tires for different kinds of uses, for example, bicycles used on rugged terrain such as woodland and sand are not desired to have the tires fully inflated because rugged and undulating terrain will result in reduced surface contact between a fully inflated tire and the ground, which may lead to insufficient gripping force of the tire against the ground and thus affect riding. Therefore, the tires of this kind of bicycle are often incompletely inflated so as to strengthen the gripping force.

However, during actual use, incompletely inflated tires will significantly reduce the service life of the tire rims because during the riding process, the rims (wheel hubs, wheel disc) of the incompletely inflated tires may be frequently and directly in contact with the ground or hard obstacles on the ground, and hence subject to great impact force, which leads to deformation of the rims in a long run which affects the service life of the rims seriously and provides poor riding experience for the users. Moreover, when incompletely inflated tires are used, the connecting parts of tire beads and the rims are so repeatedly compressed and squashed that the tires can be easily damaged, and the service life of the tires is influenced. Furthermore, during use, compressed and deformed tires may be directly separated from the rims, which is dangerous.

### BRIEF SUMMARY OF THE INVENTION

In view of the defects in the prior art, it is an object of the present invention to provide a novel tire structure, which can absorb impact force in an incompletely inflated state so as to protect a rim of the tire, prolong a service life of the tire, increase safety of use, and enhance user's experience and the like, without affecting its use in terrains such as woodland and sand.

To achieve the above object, the present invention adopts the following technical solutions:

A novel tire structure, comprising a rim, an outer tire, an inner tube, and an inflating valve; an outer peripheral surface of the rim is provided with a mounting groove circumferentially around the rim; tire beads of the outer tire are hermetically connected with side walls of the mounting groove, so that a hermetically sealed air cavity is formed between the rim and the outer tire; the inner tube is annular, and is made of an elastic porous material, with a sectional size larger than that of the air cavity; the inner tube is disposed in the air cavity so that an outer surface of the inner tube is tightly attached to an inner wall of the air cavity; and the inflating valve is mounted to the rim and is configured to inflate the air cavity and the inner tube.

Two sides of the mounting groove are raised away from the rim and along a radial direction of the rim to form two stepped portions respectively; a middle part of an inner annular surface of the inner tube is protruded inwardly and embedded between the two stepped portions.

Preferably, a limiting flange is formed on an inner side of a top surface of each of the stepped portions; the limiting flange protrudes away from and along the radial direction of the rim, and extend circumferentially around the corresponding stepped portion; when the inner tube is fitted to the inner wall of the air cavity, the limiting flange is embedded into the inner annular surface of the inner tube.

The inner tube is made of foam.

One of the side walls of the mounting groove is provided with a mounting hole; two ends of the mounting hole penetrate through an inner side and an outer side of the rim; and the inflating valve is hermetically installed in the mounting hole; alternatively, the mounting hole is arranged on a bottom wall of the mounting groove, and the inflating valve is hermetically installed in the mounting hole.

According to the above described structure, the present invention has the following technical effects:

1) The inner tube made of elastic porous material is arranged in the hermetically sealed air cavity formed between the rim and the outer tire, the inner tube is formed according to the shape of the air cavity, and the cross sectional size of the inner tube is larger than that of the air cavity, such that the air cavity can be completely filled after the inner tube is placed inside the air cavity, and hence achieving supporting and buffering effects for the outer tire. When the air cavity is in an incompletely inflated state, and the outer tire is deformed under stress, the inner tube can absorb most impact force to achieve a buffering effect, so that the impact force is prevented from being directly transmitted to the rim, and hence the rim is protected, the service life of the rim and that of the tire are prolonged, therefore the novel tire structure of the present invention is particularly suitable for tires used in terrains like woodland and sand.

2) The inner tube is made of elastic porous material, the porous structure of the inner tube can be filled with gas, so that the air cavity can be inflated normally, thus an amount of gas required to inflate the tire for normal use is ensured. Further, buffering effect can be achieved by the inner tube even if the outer tire has gas leakage, so that the tire can still be used for a period of time before reaching a maintenance point, and the potential safety hazard during the ride can be reduced. The inner tube can still be ensured to be tightly attached to the inner wall of the air cavity after the outer tire is inflated and expanded thanks to the material and the size of the inner tube, so that the functional stability is ensured.

3) Because the inner tube is made of porous material, the inner tube has the functions of sound absorption and noise reduction, after the inner tube is attached to the outer tire, when the outer tire is in contact with the ground or the ground obstacle directly and generates noise during use, the noise transmitted to the inner tube through the outer tire is absorbed by the inner tube, thereby achieving the function of noise reduction.

### BRIEF DESCRIPTION OF THE DRAWINGS

FIG. 1 is a perspective view of a specific embodiment according to the present invention;

FIG. 2 is an exploded view of a specific embodiment according to the present invention; and

FIG. 3 is a cross-sectional view of a specific embodiment according to the present invention.

Reference numerals in the figures:
1 - - - rim; 11 - - - mounting groove; 12 - - - stepped portion; 121 - - - limiting flange; 13 - - - mounting hole;
2 - - - outer tire; 21 - - - tire beads;
3 - - - inner tube;
4 - - - inflating valve; and
10 - - - air cavity.

### DETAILED DESCRIPTION OF THE INVENTION

To further explain the technical solutions of the present invention, a detailed description of the present invention is provided below through specific embodiments.

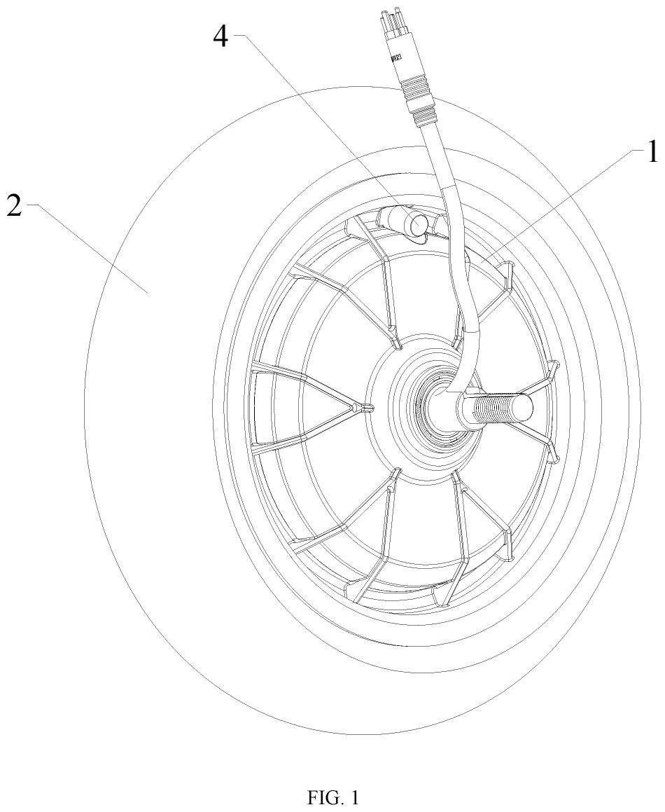

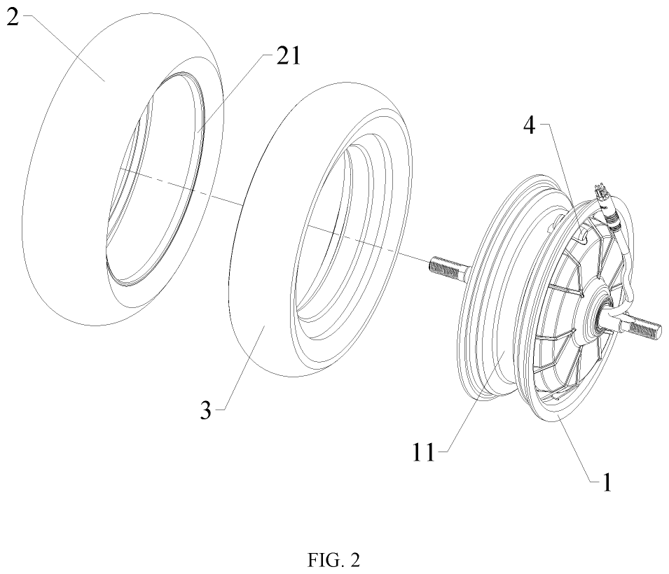

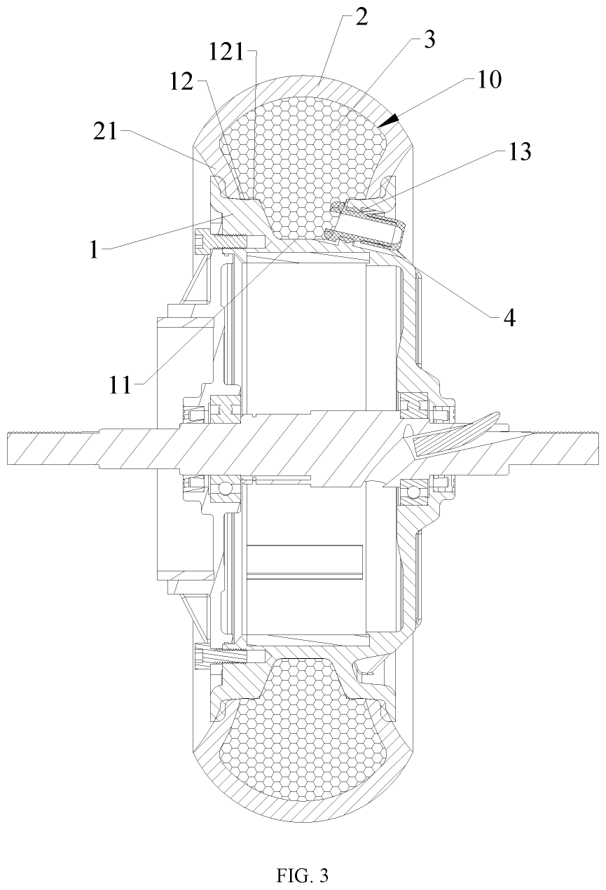

Referring to FIGS. 1 to 3, the present invention discloses a novel tire structure, comprising a rim 1, an outer tire 2, an inner tube 3, and an inflating valve 4;

an outer peripheral surface of the rim 1 is provided with a mounting groove 11 circumferentially around the rim 1;

tire beads 21 of the outer tire 2 are hermetically connected with side walls of the mounting groove 11, so that a hermetically sealed air cavity 10 is formed between the rim 1 and the outer tire 2;

the inner tube 3 is annular, and is made of an elastic porous material with a sectional size larger than that of the air cavity 10; the inner tube 3 is disposed in the air cavity 10 so that an outer surface of the inner tube 3 is tightly attached to an inner wall of the air cavity 10; and

the inflating valve 4 is mounted to the rim 1 and is configured to inflate the air cavity 10 and the inner tube 3.

The following describes specific embodiments of the present invention.

The outer tire 2 and the rim 1 are hermetically connected to each other by using prior art techniques used in making vacuum tires; the outer tire 2 may be a vacuum tire, which is a well-known prior art and thus will not be described herein.

Two sides of the mounting groove 11 are raised away from the rim 1 and along a radial direction of the rim 1 to form two stepped portions 12 respectively; a recessed portion of the mounting groove 11 is formed between the two stepped portions 12; a middle part of an inner annular surface of the inner tube 3 is protruded inwardly and embedded between the two stepped portions 12, and two sides of the inner annular surface of the inner tube 3 are rested on the two stepped portions 12 respectively; the stepped portions 12 support the inner tube 3, bear the pressure from the inner tube 3, and axially limit a position of the inner tube 3, thus ensuring structural stability. Also, the stepped portions 12 thicken the rim 1, thereby improving the strength of the rim 1. In addition, inner end surfaces of the tire beads 21 also abut against the stepped portions 12 respectively.

Furthermore, a limiting flange 121 is formed on an inner side of a top surface of each of the stepped portions 12; the limiting flange 121 protrudes away from and along the radial direction of the rim 1, and extend circumferentially around the corresponding stepped portion; when the inner tube 3 is fitted to the inner wall of the air cavity 10, the limiting flange 121 is embedded into the inner annular surface of the inner tube 3, so as to further enhance the axial limiting function of the inner tube 3.

The inner tube 3 is made of foam.

One of the side walls of the mounting groove 11 is provided with a mounting hole 13; two ends of the mounting hole 13 penetrate through an inner side and an outer side of the rim 1; and the inflating valve 4 is hermetically installed in the mounting hole 13. According to the difference of the type and specification of the rim 1, the mounting hole 13 may be arranged on a bottom wall of the mounting groove 11, so that the inflating valve 4 is positioned on an inner annular surface of the rim 1.

According to the above described structures, the inner tube 3 made of the elastic porous material is arranged in the hermetically sealed air cavity 10 formed between the rim 1 and the outer tire 2, the inner tube 3 is formed according to the shape of the air cavity 10, and the cross sectional size of the inner tube 3 is larger than that of the air cavity 10, such that the air cavity 10 can be completely filled after the inner tube 3 is placed inside the air cavity 10, and hence achieving supporting and buffering effects for the outer tire 2. When the air cavity 10 is in an incompletely inflated state, and the outer tire 2 is deformed under stress, the inner tube 3 can absorb most impact force to achieve a buffering effect, so that the impact force is prevented from being directly transmitted to the rim 1, and hence the rim 1 is protected, the service life of the rim 1 and that of the tire are prolonged, therefore the novel tire structure of the present invention is particularly suitable for tires used in terrains like woodland and sand. The inner tube 3 is made of elastic porous material, the porous structure of the inner tube can be filled with gas, so that the air cavity 10 can be inflated normally, thus an amount of gas required to inflate the tire for normal use is ensured. Further, buffering effect can be achieved by the inner tube 3 even if the outer tire 2 has gas leakage, so that the tire can still be used for a period of time before reaching a maintenance point, and the potential safety hazard during the ride can be reduced. The inner tube 3 can still be ensured to be tightly attached to the inner wall of the air cavity 10 after the outer tire 2 is inflated and expanded thanks to the material and the size of the inner tube 3, so that the functional stability is ensured. Because the inner tube 3 is made of porous material, the inner tube 3 has the functions of sound absorption and noise reduction, after the inner tube 3 is attached to the outer tire 2, when the outer tire 2 is in contact with the ground or the ground obstacle directly and generates noise during use, the noise transmitted to the inner tube 3 through the outer tire 2 is absorbed by the inner tube 3, thereby achieving the function of noise reduction.

The above embodiments and illustrations are not intended to limit the form and style of the product of the present invention. Any appropriate variations or modifications made by those of ordinary skills in the art within the scope of the present invention shall be considered as falling within the scope of the patent.

What is claimed is:

1. A tire structure, comprising:
a rim, an outer tire, an inner tube, and an inflating valve;
an outer peripheral surface of the rim is provided with a mounting groove circumferentially around the rim;
tire beads of the outer tire are hermetically connected with side walls of the mounting groove, so that a hermetically sealed air cavity is formed between the rim and the outer tire;
the inner tube is annular, and is made of an elastic porous material, with a sectional size larger than that of the air cavity; the inner tube is disposed in the air cavity so that an outer surface of the inner tube is attached to an inner wall of the air cavity; and
the inflating valve is mounted to the rim and is configured to inflate the air cavity and the inner tube.

2. The tire structure of claim 1, wherein two sides of the mounting groove are raised away from the rim and along a radial direction of the rim to form two stepped portions respectively; a middle part of an inner annular surface of the inner tube is protruded inwardly and embedded between the two stepped portions.

3. The tire structure of claim 2, wherein a limiting flange is formed on an inner side of a top surface of each of the stepped portions; the limiting flange protrudes away from and along the radial direction of the rim, and extend circumferentially around the corresponding stepped portion; when the inner tube is fitted to the inner wall of the air cavity, the limiting flange is embedded into the inner annular surface of the inner tube.

4. The tire structure of claim 1, wherein the inner tube is made of foam.

5. The tire structure of claim 1, wherein one of the side walls of the mounting groove is provided with a mounting hole; two ends of the mounting hole penetrate through an inner side and an outer side of the rim; and the inflating valve is hermetically installed in the mounting hole.
